(19) United States
(12) Patent Application Publication
(10) Pub. No.: US 2007/0144803 A1
(43) Pub. Date: Jun. 28, 2007

(54) Heat exchanger device

(75) Inventor: Klaus Schneider, Tiefenbronn (DE)

Correspondence Address: LERNER GREENBERG STEMER LLP, P O BOX 2480, HOLLYWOOD, FL, 33022-2480, US

(73) Assignee: Dr. Ing. h.c.F. Porsche AG

(21) Appl. No.: 11/645,834

(22) Filed: Dec. 26, 2006

(30) Foreign Application Priority Data
Dec. 24, 2005 (DE) 10 2005 062 297.6

(51) Int. Cl. B60K 11/00

(52) U.S. Cl. 180/68.2

(57) ABSTRACT

A heat exchanger device, in particular a cross-flow cooler for a motor vehicle, is disposed between two vehicle side rails. The heat exchanger device includes a heat-exchange zone, in particular a cooler/fin network, and at least two collecting/distributor tanks disposed to the side of the heat-exchange zone and extend substantially vertically. In order to utilize a construction space between the vehicle side rails as efficiently as possible, the collecting/distributor tanks have externally, in the region of the vehicle side rails, a respective recess configured complementary to the side rails.

### CROSS-REFERENCE TO RELATED APPLICATION

This application claims the priority, under 35 U.S.C. §119, of German application DE 10 2005 062 2976, filed Dec. 24, 2005; the prior application is herewith incorporated by reference in its entirety.

### BACKGROUND OF THE INVENTION

### Field of the Invention

The invention relates to a heat exchanger device, in particular a cross-flow cooler for a motor vehicle, which is disposed between two vehicle side rails. The heat exchanger has a heat-exchange zone, in particular a cooler/fin network, and at least two collecting/distributor tanks disposed to the side of the heat-exchange zone and extending substantially vertical.

When a heat exchanger device is conventionally fitted at the front, midway between side rails of a motor vehicle, a presentable size of the heat exchanger device is substantially formed by the distance apart of the side rails, a ground clearance and a hood height. The side rail positions are substantially determined by the spatial requirement of the engine and by the surface areas of the wheel cover surfaces of the steered wheels. The ground clearance and vehicle position over the roadway is derived from the vehicle configuration or from functional requirements in order, for example, to prevent impact with the ground in parking garages. Ultimately, as a variable for the representation of necessary heat exchanger surfaces, only the height of the heat exchanger device, and thus the hood contour, remains to be altered. In sport vehicles, in particular, and with regard to pedestrian protection, it is desirable, however, to keep a top edge of the heat exchanger device low. In high-powered vehicles with high cooling requirements, in particular, this produces a conflict of goals.

From U.S. Pat. No. 5,236,336, a heat exchanger is known which forms no continuous heat exchanger plane, but in which the heat exchanger unit, here formed by fins, forms a plurality of heat exchanger planes, mutually offset in steps. As a result of the stepped arrangement, the space available in an engine compartment of a motor vehicle, in particular, is supposedly better utilized.

### SUMMARY OF THE INVENTION

It is accordingly an object of the invention to provide a heat exchanger device which overcomes the above-mentioned disadvantages of the prior art devices of this general type, which deals with the problem of producing a heat exchanger device which makes efficient use of a maximally possible or given width between the vehicle side rails so as to be able to reduce the overall height of the heat exchanger device, given a predefined heat exchanger surface.

The invention is based on the general idea of adapting an outer contour of a heat exchanger device, for example a cross-flow cooler for a motor vehicle, disposed between two vehicle side rails, in such a way to the vehicle side rails that a formal integration of the vehicle side rails in the outer contour is produced. A construction space width between the vehicle side rails is thereby able to be efficiently used. The heat exchanger device has a heat-exchange zone, for example a cooler/fin network, and at least two collecting/distributor tanks disposed to the side of the heat-exchange zone and extend substantially vertically. The laterally disposed collecting/distributor tanks here have externally, in the region of the vehicle side rails, a respective recess configured complementary to the side rails, so that the heat exchanger surface can be led almost fully across the width between the vehicle side rails. If the surface requirement remains the same, this widened heat exchanger surface results in that its height can be reduced and hence, for example, the vehicle can be given a sporty outer contour. At the same time, the reduced height of the heat exchanger device is favorable with regard to future pedestrian protection requirements. The recess on the lateral collecting/distributor tanks can here be dimensioned such that a remaining cross section of the collecting/distributor tank in the region of the recess allows a necessary coolant exchange between the upper and the lower collecting/distributor tank portion. The lateral collecting/distributor tanks thus embrace the vehicle side rail in the region of the recess and continue above and below the same, so that the heat exchanger surface located between the lateral collecting/distributor tanks can be made wider.

According to a preferred embodiment of the solution according to the invention, at least in the case of one of the collecting/distributor tanks, in the region of the recess there are disposed internal and/or external connecting lines, which connect a portion of the collecting/distributor tank located above the recess to a portion located below the recess. Should a cross-sectional tapering of the lateral collecting/distributor tanks in the region of the recess be dimensioned such that a sufficient coolant exchange between the upper and the lower portion of the respective collecting/distributor tank is no longer sufficient, then external connecting lines can here be provided which ensure the necessary coolant exchange. Alternatively, an existing connecting hose can also, of course, be split such that each collecting/distributor tank acquires a connection of its own and hence the heat exchanger device has two forward-circuit and two return-circuit connecting branches.

According to a further advantageous embodiment of the invention, at least one of the lateral collecting/distributor tanks has in the region of the recess a separating web, which seals a portion located above the recess against a portion of the collecting/distributor tank located below the recess. Such a separating web of this type makes it possible, for example, to divide the heat exchanger device into two heat-exchange zones, namely a zone located above the recess and a zone located below the recess. Through simple configuration modifications, the heat exchanger device can hence be adapted to respective vehicle-specific requirements. The introduction of the at least one separating web requires only slight changes to the production process for the heat exchanger device, enabling a usage spectrum of the heat exchanger device according to the invention to be widened.

Expediently, the two portions of the collecting/distributor tanks located above the recess are serially connected to the two portions located below the recess, or are fluidically separated from these. In particular, the latter variant offers the possibility of dividing the heat exchanger device into two different and self-sufficient cooling zones and hence to create with a single heat exchanger device at least two different cooling circuits. With two fluidically separated portions, moreover, a better equal distribution of a heat exchanger medium within the heat exchanger device is achieved, since dead water areas which can arise with inflow and outflow connecting branches located diagonally opposite each other can be significantly diminished, allowing the capacity of the heat exchanger device to be increased.

According to a particularly preferred embodiment of the solution according to the invention, when the heat exchanger device is mounted in the motor vehicle, the vehicle side rails intrude at least partially into the complementary recesses of the collecting/distributor tank. This results in that the two collecting/distributor tanks are disposed substantially above and below the vehicle side rails and thus a region between the two vehicle side rails can be utilized almost exclusively by the heat-exchange zone. Such a heat-exchange zone is significantly wider than in traditional heat exchanger devices which are disposed wholly between the vehicle side rails.

Other features which are considered as characteristic for the invention are set forth in the appended claims.

Although the invention is illustrated and described herein as embodied in a heat exchanger device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic illustration of a heat exchanger device according to the invention,

FIG. 2 is a diagrammatic illustration according to FIG. 1, but with one collecting/distributor tank having a separating web; and

FIG. 3 is a diagrammatic illustration according to FIG. 1, but with both collecting/distributor tanks respectively having a separating web.

### DESCRIPTION OF THE PREFERRED EMBODIMENTS

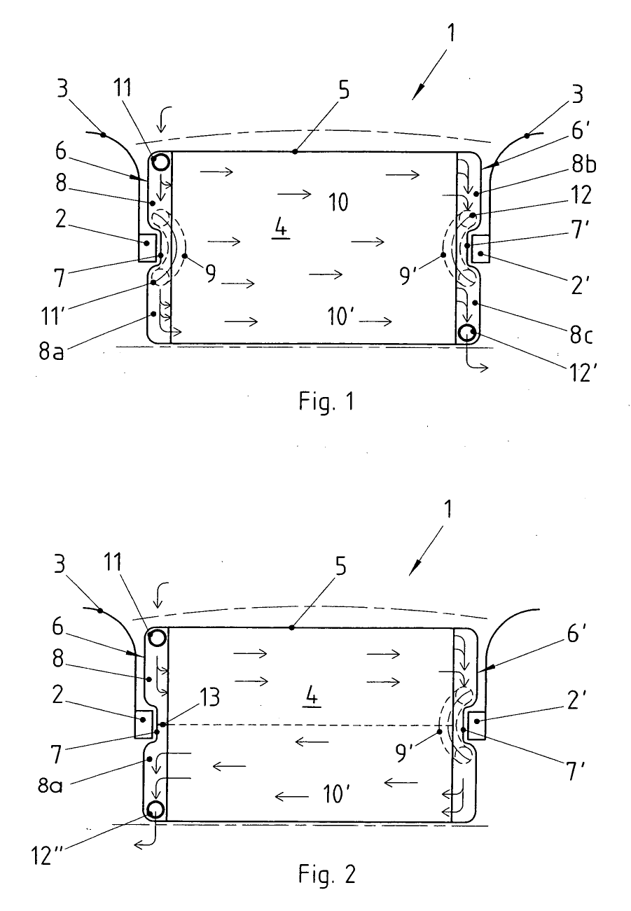

Referring now to the figures of the drawing in detail and first, particularly, to FIG. 1 thereof, there is shown an installation position of a heat exchanger device 1 according to the invention that is shown midway between two side rails 2 and 2′, a presentable size of the vertically disposed heat exchanger device 1 being substantially determined by the distance apart of the two side rails 2, 2′, a ground clearance and a hood height. The position of the vehicle side rails 2, 2′ is substantially defined by the spatial requirement of a non-illustrated drive mechanism and by wheel cover surfaces 3 of non-illustrated steered wheels.

In order to make best possible use of a space between the two vehicle side rails 2, 2′, or in order to keep a top edge 5 of the heat exchanger device 1 as low as possible, given a predefined size of heat exchanger surface 4, an outer contour of the heat exchanger device 1 should be matched as exactly as possible to the internal dimensions of the available construction space. To this end, the solution according to the invention proposes to recess at least two collecting/distributor tanks 6, 6′, disposed to the side of the heat-exchange zone 4 and extending substantially vertically, externally in the region of the vehicle side rails 2, 2′, in each case complementary to these latter, i.e. to provide them with outer recesses 7. Such a recess 7 causes a cross section of the respective collecting/distributor tank 6, 6′ to be strongly tapered in the region of the recess 7. In the collecting/distributor tank 6, the recess 7 thus serves to divide it into a portion 8 located above the recess 7 and a portion 8a located below the recess 7. Analogously thereto, the recess 7′ divides the other collecting/distributor tank 6′ into a portion 8b located above the recess 7′ and a portion 8c located below it.

In order to allow a sufficient coolant exchange between the portion 8 and 8a and 8b and 8c respectively, in at least one of the collecting/distributor tanks 6, 6′ there are disposed in the region of the recess 7, 7′ internal and/or external connecting lines 9, 9′, which connect the portion 8, 8b located above the recess 7, 7′ to the portion 8a, 8c located below the recess 7, 7′, respectively. Alternatively thereto, an existing non-illustrated connection hose can also, of course, be split and the heat exchanger device 1 can be divided into a heat exchanger portion 10 located above the recess 7 or 7′ and a heat exchanger portion 10′ located below it, each heat exchanger portion 10, 10′ then acquiring an inflow 11 and 11′ and an outflow 12 and 12′ respectively.

As shown in FIG. 1, the heat exchanger device 1 is basically configured as a cross-flow cooler, so that a heat exchanger medium emanating, for example, from a collecting/distributor tank 6 flows substantially horizontally through the heat-exchange zone 4 and subsequently reaches the collecting/distributor tank 6′.

In order to be able to increase a functionality of the heat exchanger device 1 and to be able to widen a range of application, at least one of the lateral collecting/distributor tanks 6, 6′ can have in the region of the respective recess 7, 7′ a separating web 13, 13′, which fluidically seals the portion 8, 8b located above the recess 7, 7′ against the portion 8a, 8c located below the recess 7, 7′. As is shown in FIG. 2, the collecting/distributor tank 6 is fluidically divided by the separating web 13 into previously stated portions, thereby producing a flow through the heat exchanger device 1 which is altered compared to FIG. 1. In FIG. 2, cooling medium flows via the inflow 11 into the upper heat exchanger portion 10 and flows through this from left to right up to the portion 8b of the collecting/distributor tank 6′. Via the connecting line 9′ or the tapered cross section in the recess 7′, the cooling medium now flows from the portion 8b into the portion 8c located below the recess 7′ and enters from there into the heat exchanger portion 10′. This is now flowed through from right to left until the portion 8a of the collecting/distributor tank 6 is reached. After this, the heat exchanger medium leaves the portion 8a of the collecting/distributor- tank 6 via an outflow 12″. The heat exchanger portion 10 and the heat exchanger portion 10′ are thus flowed through successively and are serially connected.

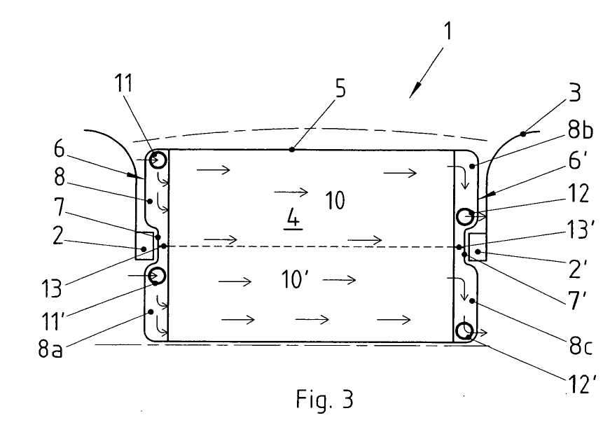

As shown in FIG. 3, both the collecting/distributor tank 6 and the collecting/distributor tank 6′ have in the region of the respective recess 7, 7′ the separating web 13 and 13′ respectively, so that the heat exchanger portion 10 is fluidically separated from the heat exchanger portion 10′. This offers the possibility of providing two mutually independent and self-sufficient heat exchanger and cooling circuits. Within a single heat exchanger device 1, for example, high-temperature and low-temperature coolers can thus also be realized, which serve specifically for the cooling of certain systems. A water-side oil cooling functions better, for example from a thermodynamic viewpoint, if an inlet temperature has a considerable temperature difference, whereas a cooling water for a drive mechanism functions better, from a thermodynamic viewpoint, if it has a small temperature difference. As shown in FIG. 3, both heat exchanger portions 10, 10′ have an own inflow 11, 11′ and an own outflow 12, 12′. According to FIGS. 1 to 3, the arrangement of the inflows 11 and outflows 12 is here only represented by way of example, so that other flow directions, too, are intended to be covered by the invention.

In summary, the significant features of the solution according to the invention can be characterized as now described.

In order to utilize a construction space between two vehicle side rails 2, 2′ as efficiently as possible and to keep a structural height-of the heat-exchanger-device 1 as low as possible for configuration and/or safety reasons, it is proposed to adapt an outer contour of the heat exchanger device 1, in the region of the vehicle side rails 2, 2′, to these latter. To this end, the collecting/distributor tanks 6, 6′ disposed respectively to the side of the heat-exchange zone 4 have externally, in the region of the vehicle side rails 2, 2′, the respective recess 7, 7′ formed complementary to the vehicle side rails. In the case of the heat exchanger device 1 installed in a motor vehicle, the vehicle side rails 2, 2′ thus intrude at least partially into the recess 7, 7′, thereby allowing the heat-exchange zone 4 to have a greater width. Given a predefined surface size of the heat-exchange zone 4, the height thereof can hence be reduced.

I claim:

1. A heat exchanger device disposed between two vehicle side rails, the heat exchanger device comprising:
a heat-exchange zone; and
at least two collecting/distributor tanks each disposed on a side of said heat-exchange zone and extending substantially vertically, said collecting/distributor tanks have externally, in a region of the vehicle side rails, a respective recess formed therein and configured complementary to the vehicle side rails.

2. The heat exchanger device according to claim 1, wherein at least one of said collecting/distributor tanks, in a region of said respective recess, has at least one of internal and/or external connecting lines connecting a portion of said one collecting/distributor tank disposed above said respective recess to a portion disposed below said respective recess.

3. The heat exchanger device according to claim 1, further comprising an inflow inlet and an outflow outlet, said inflow inlet disposed above said respective recess of a first of said collecting/distributor tanks and said outflow outlet disposed below said respective recess of a second of said collecting/distributor tanks.

4. The heat exchanger device according to claim 1, further comprising a separating web, at least one of said collecting/distributor tanks has in a region of said respective recess said separating web, for sealing a first portion disposed above said respective recess against a second portion of said at least one collecting/distributor tank disposed below said respective recess.

5. The heat exchanger device according to claim 4, wherein said first portion of both of said collecting/distributor tanks disposed above said respective recess are serially connected to said second portion of both of said collecting/distributor tanks disposed below said respective recess.

6. The heat exchanger device according to claim 4, wherein said first portion of both of said collecting/distributor tanks disposed above said respective recess are serially connected to each other but fluidically separated from said second portion of said collecting/distributor tanks disposed below said respective recess.

7. The heat exchanger device according to claim 1, wherein said heat-exchange zone and said at least two collecting/distributor tanks define at least one heat exchanger circuit.

8. The heat exchanger device according to claim 1, wherein said said heat-exchange zone and said at least two collecting/distributor tanks define two heat exchanger circuits being fluidically separated from one another and include a first heat exchanger circuit and a second heat exchanger circuit, said first heat exchanger circuit having a higher working temperature than said second heat exchanger circuit.

9. The heat exchanger device according to claim 1,
wherein said said heat-exchange zone and said at least two collecting/distributor tanks define two heat exchanger circuits being fluidically mutually separated from one another, said two heat exchanger circuits being mutually separate heat exchanger circuits defined above and below said recess;
further comprising an inflow inlet disposed on a first portion of each of said heat exchanger circuits; and
further comprising an outflow outlet disposed on a second portion of each of said heat exchanger circuits.

10. The heat exchanger device according to claim 1, wherein the heat exchanger device is mounted in a motor vehicle, the vehicle side rails intrude at least partially into said recess of both of said two collecting/distributor tanks and are complementary recesses to said vehicle side rails.

11. The heat exchanger device according to claim 1, wherein said heat-exchange zone is a cooler/fin network.

12. The heat exchanger device according to claim 1, wherein the heat exchanger device is a cross-flow cooler for a motor vehicle.

13. The heat exchanger device according to claim 1, further comprising an inflow inlet and an outflow outlet, said outflow inlet disposed above said respective recess of a first of said collecting/distributor tanks and said inflow outlet disposed below said respective recess of a second of said collecting/distributor tanks.
